(19) United States
(12) Patent Application Publication
(10) Pub. No.: US 2017/0093463 A1
(43) Pub. Date: Mar. 30, 2017

(54) DEVICE AND METHOD FOR CONTROLLING ELECTRONIC DEVICE TO ACT IN A BATTERYLESS MANNER AND USE THEREOF

(71) Applicant: YEE TAK WONG, KOWLOON (HK)

(72) Inventors: Xian Wang, Atlanta, GA (US); Yee Tak Wong, Kowloon (HK)

(21) Appl. No.: 15/126,729

(22) PCT Filed: Mar. 17, 2014
(86) PCT No.: PCT/CN2014/073551

§ 371 Date: Sep. 16, 2016

(51) Int. Cl. H04B 5/00; G06Q 20/32

(52) U.S. Cl. CPC H04B 5/0037; H04B 5/0081; H04B 5/0031; G06Q 20/3278

(57) ABSTRACT

An NFC-based method for controlling an electronic device to perform a pre-determined action in a batteryless manner is provided, comprising the steps of providing at least one near field communication (NFC) tag which comprises a integrated circuit configured to activate the electronic device to perform the respective pre-determined action after the circuit is energized and an antenna electrically coupled to the integrated circuit and configured to harvest NFC energy from the electronic device to energize the integrated circuit; forming an operation loop comprising one of the at least one NFC tag; switching the operation loop between an operative state wherein the antenna is capable of harvesting the NFC energy to energize the integrated circuit, and a non-operative state wherein the antenna fails to harvest the NFC energy so as to disable the integrated circuit. A corresponding apparatus and applications of the apparatus are also described.

### TECHNICAL FIELD OF THE INVENTION

The present invention generally relates to a method and an apparatus for wirelessly controlling electronic devices. More specifically, the present invention concerns a method and an apparatus for wirelessly controlling an electronic device to act in a batteryless manner based on near field communication (NFC) as well as application of the same.

### BACKGROUND OF THE INVENTION

Wireless controllers are very popular among current control environments. The fundamental techniques implied can be generally divided into five categories: radio communication, microwave communication, light (both visible and infrared) communication, sonic (especially ultrasonic) communication and electromagnetic induction communication. Some of these techniques are used only for short range communication due to the loss and attenuation in the conductive medium, while some of them are used both in short range and long range communication. In the conventional wireless control, the controller generally generates an instruction and sends it to the receiver which performs a certain task according to that instruction. This configuration requires the controller to consume power (usually supplied by a battery) when transmitting instructions. In recent decades, some technologies that allow energy harvesting by wireless controllers have been developed. However, they only serve as an auxiliary to the battery which extends the life of the battery but cannot replace it completely, as the signal modulation consumes a lot of energy that cannot be easily harvested externally.

Radio-frequency identification (RFID) is the wireless non-contact use of radio-frequency electromagnetic field to transfer data for the purpose of automatically identifying and tracking tags attached to an object. According to practical needs, a mechanically manipulated or electronically manipulated switch can be added to a RFID tag to activate or deactivate the tag. For example, U.S. Pat. No. 6,025,780 describes an electronic security system using RFID tags. An electronic, physical or virtual deactivation event may be performed on the tag when legitimate access is obtained to the tagged object. The deactivation may be performed through a switch placed in the circuit of the RFID tag which is able to disconnect or short out part of the circuit, so as to prevent information transfer between the RFID tag and an interrogator.

Near field communication (NFC) is a contactless-type short range wireless communication technology developed based on RFID. In NFC, the communication devices operate in close proximity, usually in the order of 10 centimeters, and consume very little power. As a result, NFC is becoming increasingly prevalent for exchanging and sharing information and many electronic devices are incorporating a NFC system to become NFC compatible communication devices. As NFC tags are powered by energy that is broadcast in the form of electromagnetic waves in the radio frequency, they don't need to be tethered to a power source in order to send out signals, rendering them to be a promising candidate as batteryless wireless controllers. However, NFC-based batteryless wireless controllers have not been found in prior art so far. Therefore, there is a need for innovative method and apparatus utilizing the NFC technologies for wirelessly controlling an electronic device to perform pre-determined actions in a batteryless manner.

### SUMMARY OF THE INVENTION

The present invention has a principle object of providing method and apparatus for wireless control of an electronic device, for example, a mobile phone, a tablet computer, or a digital camera, in a batteryless manner. One of the major advantages of the present invention is that it does not require a power source, for example a battery, which is usually indispensable in existing wireless controllers. The power needed to drive the apparatus according to the present invention will be broadcast in the form of electromagnetic waves in the radio frequency provided by the electronic device to be controlled and harvested by the apparatus. Therefore, the problem of limited battery life in existing wireless controllers is eliminated thoroughly.

Another object of the present invention is to provide method and apparatus for wireless control of an electronic device by mechanically manipulating the controlling apparatus. As the manipulation of the controlling apparatus is mechanical rather than electronic or virtual, the operation of the controlling apparatus will be more precise and more reliable. Accidental misoperation of the controlling apparatus will be reduced. In addition, unauthorized control of the target electronic device will be more effectively prevented, and valuable information stored in the electronic device, such as personal account data, can be better protected.

As the method and apparatus for wireless control of an electronic device according to the present invention are based on NFC, other communication ports commonly found in electronic devices, such as mini USB port or Bluetooth port, remain available for other applications and would not be occupied. This is particularly advantageous as most of the electronic devices today are multi-functional.

These and other objects and advantages of the invention are satisfied by a first aspect of the invention, which provides an apparatus for controlling an electronic device to perform at least one pre-determined action in a batteryless manner, comprising:

at least one NFC tag which comprises an integrated circuit configured to activate the electronic device to perform the respective pre-determined action after the circuit is energized, and an antenna electrically coupled to the integrated circuit and configured to harvest NFC energy from the electronic device to energize the integrated circuit; and
at least one switch device configured to switch a batteryless operation loop between an operative state wherein the antenna is capable of harvesting the NFC energy to energize the integrated circuit, and a non-operative state wherein the antenna fails to harvest the NFC energy so as to disable the integrated circuit, said operation loop being formed by one of the at least one NFC tag together with the respective switch device.

The term “NFC energy” used herein refers to radio frequency energy transmitted by NFC.

According to the present invention, the NFC tag may be configured to contain tag identification and instruction and information associated with the pre-determined action, which are readable by the electronic device to perform the respective pre-determined action.

In one embodiment of the present invention, the at least one switch device may be provided as a mechanical switch for switching on and off the integrated circuit so as to switch the operation loop between the operative state and the non-operative state.

In another embodiment of the present invention, the at least one switch device may be provided as a mechanical switch for altering a shape or a size of the antenna, for example shortening an effective length of the antenna, such that the NFC energy harvested by the integrated circuit does not suffice to activate the electronic device to perform the respective pre-determined action.

The apparatus according to the present invention may be detachably mounted to the electronic device, for example, selected from the group consisting of a mobile phone, a tablet computer, and a digital camera.

The pre-determined action may be selected from the group consisting of launching an application program installed in the electronic device, visiting a website, and executing a task in an application program installed in the electronic device. The execution of a task may comprise effecting mobile payment, wherein the electronic device is provided with means for preventing launch of the payment unless the means for preventing receives a signal from the NFC tag.

In one embodiment of the present invention, a plurality of NFC tags of the apparatus according to the present invention may be configured to use a common antenna. In another embodiment of the present invention, each of the NFC tags has a respective antenna.

The switch device of the apparatus according to the present invention may be in the form of a button. For example, the button may switch the operation loop to the operative state when pressed, and switch the operation loop to the non-operative state when not pressed.

A second aspect of the present invention provides a method for controlling an electronic device to perform a pre-determined action in a batteryless manner, comprising the steps of:

providing at least one NFC tag which comprises an integrated circuit configured to activate the electronic device to perform the respective pre-determined action after the circuit is energized, and an antenna electrically coupled to the integrated circuit and configured to harvest NFC energy from the electronic device to energize the integrated circuit;
forming a batteryless operation loop comprising one of the at least one NFC tag; switching the operation loop between an operative state wherein the antenna is capable of harvesting the NFC energy to energize the integrated circuit, and a non-operative state wherein the antenna fails to harvest the NFC energy so as to disable the integrated circuit.

In one embodiment of the present invention, the switching step comprises switching on and off the integrated circuit so as to switch the operation loop between the operative state and the non-operative state.

In another embodiment of the present invention, the switching step comprises altering a shape or a size of the antenna, for example shortening an effective length of the antenna, such that the NFC energy harvested by the integrated circuit does not suffice to activate the electronic device to perform the respective pre-determined action.

According to the second aspect of the invention, the pre-determined action may be selected from the group consisting of launching an application program installed in the electronic device, visiting a website, and executing a task in an application program installed in the electronic device. The execution of a task may comprise effecting mobile payment, wherein the payment is effected only after a signal from the NFC tag is received in the electronic device.

The third aspect of the present invention relates to use of the apparatus according to the present invention for controlling an electronic device to perform at least one pre-determined action in a batteryless manner, and to use of the apparatus according to the present invention as an input device for inputting information.

The objects, characteristics, advantages and technical effects of the invention will be further elaborated in the following description of the concepts and structures of the invention with reference to the accompanying drawings.

### BRIEF DESCRIPTION OF THE DRAWINGS

FIG. 1 shows an exemplary operation loop of an apparatus constructed according to a first embodiment of the present invention.

FIG. 2 is a flow chart of a process of operating the first embodiment shown in FIG. 1.

FIG. 3 shows an exemplary operation loop of an apparatus constructed according to a second embodiment of the present invention.

FIG. 4 illustrates an array of NFC tags with respective antennas and in communication with the electronic device to be controlled according to a third embodiment of the present invention.

FIG. 5 illustrates an array of NFC tags with a common antenna and in communication with the electronic device to be controlled according to a fourth embodiment of the present invention.

FIG. 6 shows a smart phone case according to a fifth embodiment of the present invention.

FIG. 7 is a flow chart of a process of controlling an electronic device to perform mobile payment according to a sixth embodiment of the present invention using the apparatus of the present invention.

FIG. 8A shows an apparatus according to a seventh embodiment of the present invention configured as an input device for inputting information to an electronic device, wherein each of the multiple NFC tags has a respective antenna.

FIG. 8B shows the internal structure of the apparatus shown in FIG. 8A.

FIG. 9A shows an apparatus according to an eighth embodiment of the present invention configured as an input device for inputting information to an electronic device, wherein the multiple NFC tags use a common antenna.

FIG. 9B shows the internal structure of the apparatus shown in FIG. 9A.

### DETAILED DESCRIPTION OF THE INVENTION

While this invention is illustrated and described in preferred embodiments, the device of the invention may be constructed in many different configurations, sizes, forms and materials; and the method of the invention may be implemented in different ways.

The device according to the present invention for wirelessly controlling an electronic device (referred to as “target electronic device” hereinafter) is an apparatus constructed based on the NFC technology and configured to operate in a batteryless manner. The apparatus may be operated by mechanical manipulation, providing advantages of better reliability and safety, for example.

In the conventional application of a NFC tag, the NFC tag would send tag information to a NFC reader once the NFC tag and the NFC reader are within the transmitting range (typically in the order of 10 centimeters) where the NFC tag is able to receive NFC energy from the NFC reader. The invention is developed based on this principle.

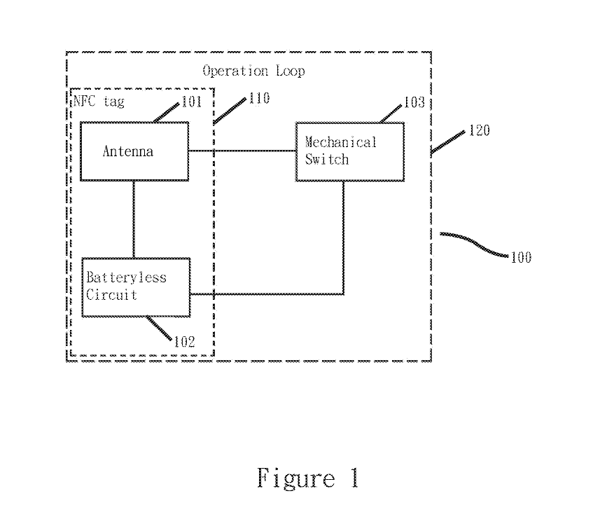

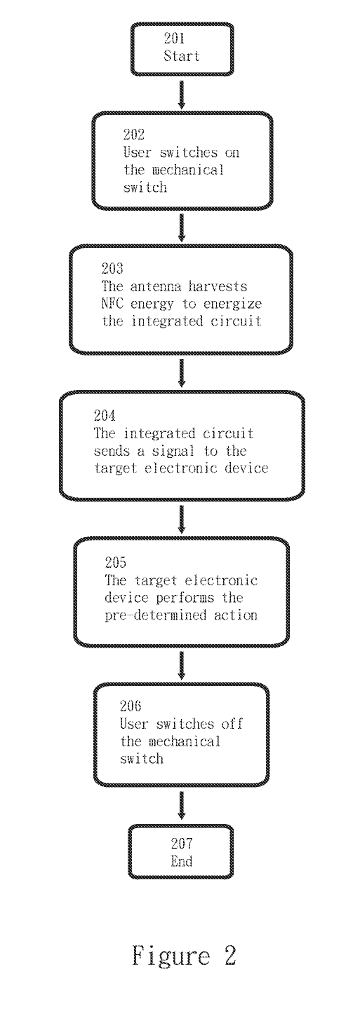

Referring now to FIGS. 1 and 2, there is illustrated a first embodiment of the present invention. FIG. 1 shows an apparatus 100 constructed according to a first embodiment of the invention. In this embodiment, the apparatus 100 comprises a NFC tag 110 comprising antenna 101 and an integrated circuit (IC) 102, and a mechanical switch 103. The antenna 101, the integrated circuit 102 and the switch 103 are connected in series together, forming a batteryless operation loop 120 which is switchable between a closed operative state and an open non-operative state by the switch 103.

The antenna 101 can be of any type, shape and size known in the art and would be within the ability of a person skilled in the art. So the antenna 101 will not be described in detail herein since it is not the essence of the invention.

The integrated circuit of a conventional NFC tag may be used as the integrated circuit 102. For example, it may comprise a modulator, an encoder, a decoder, an EEOROM memory, etc. Such an integrated circuit would also be within the knowledge of a person skilled in the art, and therefore would not be described in detail herein.

The NFC tag comprising the antenna 101 and the integrated circuit 102 is configured to contain tag identification, instructions and information associated with a pre-determined action to be performed by a target electronic device, which are readable by the target electronic device. For example, the tag identification and instruction and information associated with the pre-determined action are stored in the EEOROM memory of the integrated circuit 102.

A mechanical switch 103 is electrically connected in series and between the antenna 101 and the integrated circuit 102. The mechanical switch 103 can be of any type known in the art that is switchable. When the switch 103 is switched on, the operation loop 120 becomes a closed loop which is in the operative state. When the switch 103 is switched off, the operation loop 120 is opened, which is in the non-operative state. In one preferred embodiment of the invention, the mechanical switch 103 is provided in the form of a button, which is used to switch on the operation loop 120 when pressed, and switch off the operation loop when released.

The operation loop 120 is of batteryless configuration, which means it requires no power source in any form or of any type. The energy needed for the operation loop 120 to operate is the NFC energy harvested by the antenna 101, which is broadcast by the target electronic device.

When the operation loop 120 is in the operative state, the antenna 101 harvests NFC energy broadcast by the target electronic device and energizes the integrated circuit 102. The energized integrated circuit 102 transmits a signal comprising the tag identification and instruction and information associated with the pre-determined action via the antenna to the target electronic device. Upon receiving the signal, the target electronic device read the received data to perform the pre-determined action according to the information contained in the signal.

When the operation loop 120 is in the non-operative state, the antenna 101 is disabled to harvest NFC energy, and the integrated circuit 102 is not energized, and therefore no electronic communication happens between the NFC tag and the target electronic device.

It should be noted that although in this embodiment the mechanical switch 103 is placed between the antenna 101 and the integrated circuit 102, it is possible to configure the switch 103 anywhere as long as the switching on and off of the switch 103 causes the operation loop 120 to be closed and opened. For example, the switch 103 can be positioned between any two components (such as the modulator and the encoder) of the integrated circuit 102.

FIG. 2 shows a flow chart of the process of operating the apparatus shown in FIG. 1 to control an electronic device to perform a pre-determined action in a batteryless manner. The process starts at step 201. When the user wants to activate the target electronic device to perform a pre-determined action, he mechanically switches on the mechanical switch 103 to close the operation loop 120 in step 202. This means the operation loop 120 is switched into the operative state. In step 203, the antenna 101 harvests NFC energy broadcast by the target electronic device to energize the integrated circuit 102, which then sends a signal comprising the tag identification and instruction and information associated with the pre-determined action via the antenna 101 to the target electronic device in step 204. After the target electronic device performs the pre-determined action according to the instruction and information contained in the signal in step 205, the user switches off the mechanical switch 103 in step 206, and the process ends at step 207.

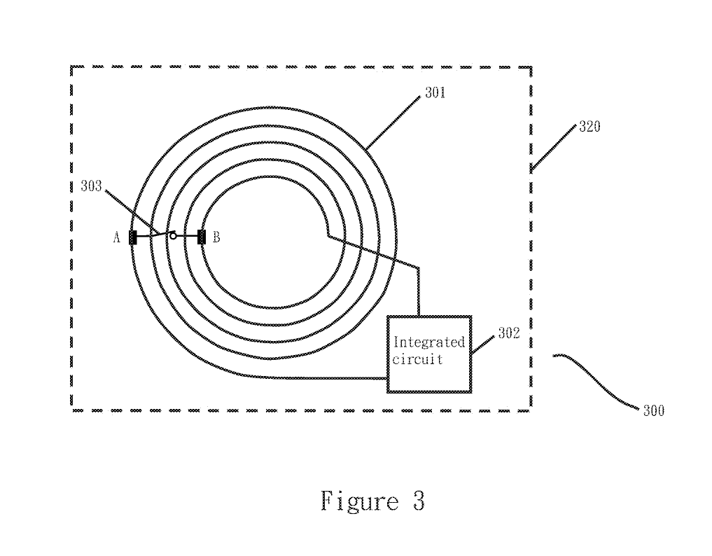

FIG. 3 shows a second embodiment of the present invention, which is similar to the first embodiment as illustrated in FIGS. 1 and 2, except that the mechanical switch 303 is placed between point A and point B of the antenna 301 to vary the effective length of the antenna 301, thereby controlling the operation loop 320 is switchable between the operative state and the non-operative state. In the NFC technology, the antenna 301 needs to have a long enough effective length in order to harvest sufficient NFC energy to energize the integrated circuit 302. If the effective length of the antenna 301 is shortened to become disabled to harvest the sufficient NFC energy, the integrated circuit 302 would not be energized and accordingly the operation loop 320 is switched into the non-operative state. In this embodiment, when the switch 303 is switched to connect point A and point B, the effective length of the antenna 301 is shortened, with the result that the integrated circuit 302 cannot receive enough energy from the antenna 301, and thus the operation loop 320 is switched into the non-operative state. When the switch 303 is switched to disconnect point A and point B, the full effective length of the antenna 301 is recovered and the integrated circuit 302 is adequately energized to send a signal to the target electronic device, which is activated to perform the pre-determined action according to the signal. The subsequent process of operating the apparatus in this embodiment is the generally same to the process shown in FIG. 2.

It should be noted that, besides the configuration shown in FIG. 3, any other configuration of the apparatus in which the shape or the size of the antenna 301 can be altered by mechanically switching the switch 303 is also within the scope of the present invention, as long as the alteration of the shape or the size of the antenna 301 leads to the harvesting of the NFC energy which allows to switch the operation loop 320 between the operative state and the non-operative state.

In addition to the above first and second embodiments, there are many other ways to switch the operation loop between the operative state and the non-operative state as well. For example, the switch may be configured to create a gap in the antenna so as to switch the operation loop into the open non-operative state, and to reconnect the gap so as to switch the operation loop into the closed non-operative state. These configurations are also within the scope of the present invention.

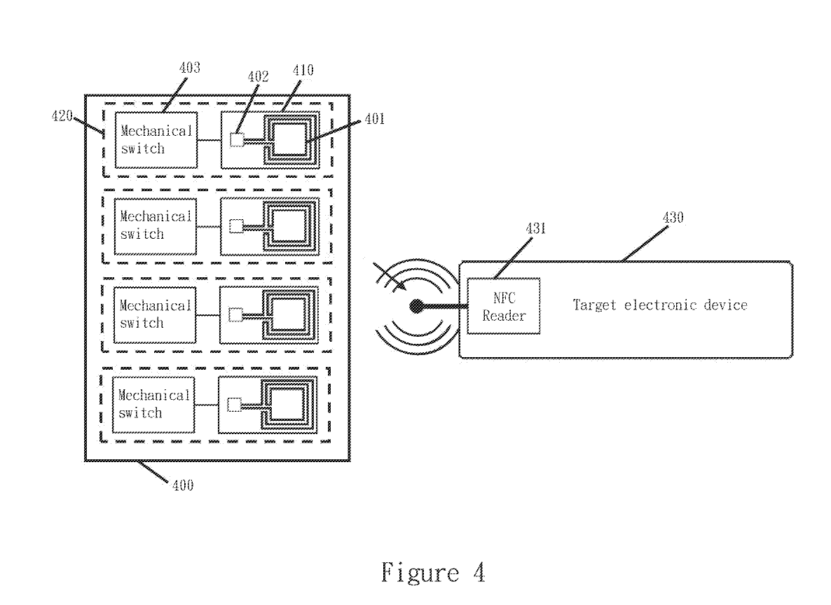

According to a third embodiment of the present invention, a plurality of operation loops 420 are constructed and positioned in an array, as illustrated in FIG. 4, with each of the operation loops 420 corresponding to a respective pre-determined action to be performed by the target electronic device 430. In this embodiment, the apparatus 400 according to the present invention comprises four operation loops 420. Each of the operation loops 420 has an NFC tag 410 comprising an antenna 401 and an integrated circuit 402, and a mechanical switch 403. The mechanical switch 403 may be electrically connected to the NFC tag 410 in the same way as the first and second embodiments.

The target electronic device 430 may comprise an NFC reader 431. When the NFC reader 431 receives a signal from the apparatus 400, the target electronic device 430 may respond in terms of tag identification matching and launching a response to the signal. The target electronic device 430 and the NFC reader 431 are both within the knowledge and ability of a person skilled in the art, and are not be described in detail as they are not the essence of the invention.

Each of the operation loops 420 is constructed according to the first embodiment or the second embodiment. The NFC tag 410 of each of the operation loops 420 contains a unique tag identification, instructions and information associated with a respective pre-determined action to be performed by the target electronic device 430. When one of the operation loops 420 is switched into the operative state by mechanically switching the switch 403, the corresponding NFC tag 410 sends a signal to the target electronic device. The signal may contain identification of this specific tag, instructions and information associated with a respective pre-determined action to be performed by the target electronic device 430. Upon receiving the signal from the NFC tag 410, the target electronic device 430 performs the pre-determined action according to the received instructions and information. The target electronic device 430 may conduct tag identification matching before performing the pre-determined action. The user can switch the switch 403 for one of the operation loops 420 at a time to activate the target electronic device 430 to perform one corresponding pre-determined action.

Although the apparatus according to this embodiment comprises four operation loops 420, it would be appreciated that the apparatus can comprise more or less than four operation loops 420, without departing from the scope of the present invention.

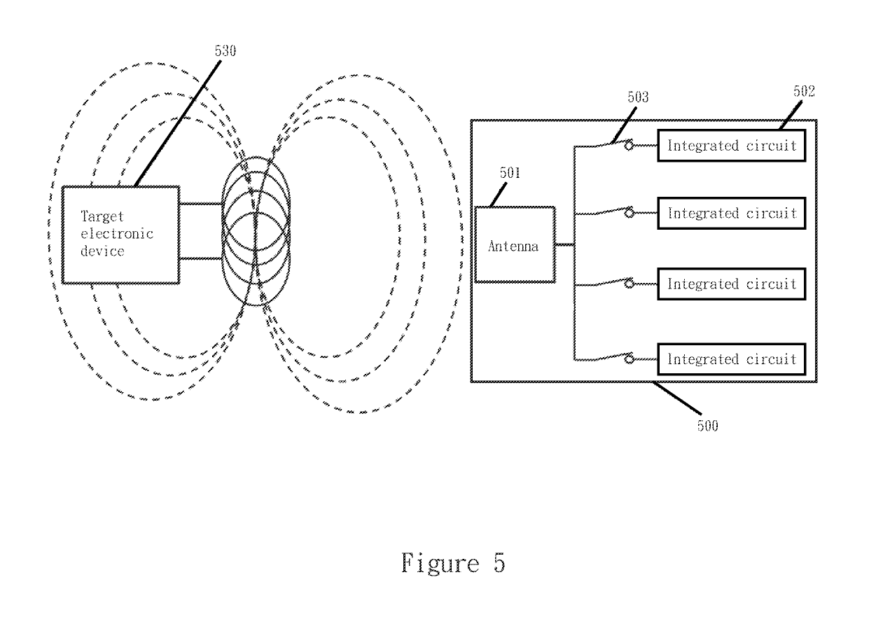

FIG. 5 shows a fourth embodiment of the present invention, which is the same as the third embodiment but differs in that the plurality of operation loops are configured to use a common antenna 501. In this embodiment, the apparatus 500 comprises four integrated circuits 502, each of which is electrically connected to one of four mechanical switches 503, respectively. The four switches 503 are then connected to a common antenna 501. Each integrated circuit 502 contains a unique tag identification, instructions and information associated with a respective pre-determined action to be performed by the target electronic device 530. The operation of the apparatus 500 to control the target electronic device 530 may be made reference to the third embodiment. Any one of the integrated circuits 502 is switched on using the respective switch 503 to be energized by the NFC energy harvested by the common antenna 501. The energized integrated circuit 502 then sends a signal to the target electronic device 530, which signal contains identification of this specific integrated circuit 502, instructions and information associated with a respective pre-determined action to be performed by the target electronic device 530. Upon receiving the signal, the target electronic device 530 performs the pre-determined action according to the received instructions and information contained in the signal. Likewise, the user can switch one of the switches 503 at a time to activate the target electronic device 530 to perform one corresponding pre-determined action.

Although the apparatus according to this embodiment comprises four integrated circuits 502 and correspondingly four switches 503, it would be appreciated that the apparatus can comprise more or less than four integrated circuits 502 and more or less than four switches 503 if necessary, without departing from the scope of the present invention.

The method and apparatus according to the present invention find a wide range of applications in numerous aspects. For example, the apparatus may be an accessory detachably mounted to the electronic device, which is for example selected from the group consisting of a mobile phone, a tablet computer, and a digital camera.

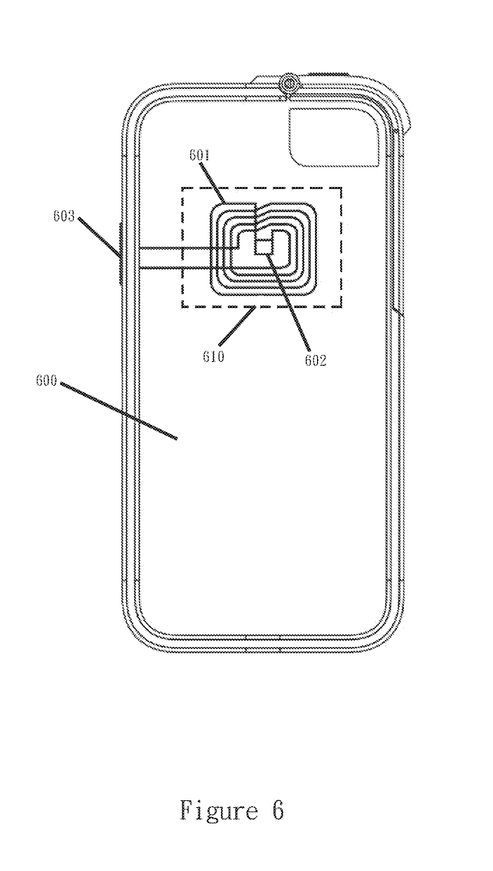

In a fifth embodiment of the present invention, the target electronic device is a smart phone equipped with NFC capability, and the apparatus is attached to a phone case 600 of the smart phone, as shown in FIG. 6. The smart phone may be of any type well known in the art and therefore will not be described in detail herein. An NFC tag 610 is detachably mounted on the inner surface of the phone case and comprises an antenna 601 and an integrated circuit 602, as well as a mechanical switch 603. The mechanical switch 603 is electrically connected to the NFC tag in the same ways as the first or second embodiment. As shown in FIG. 6, the switch 603 is positioned on the left side of the phone case 600. It shall be understood that the switch 603 may also be placed at other positions, for example, on the right, top or bottom side or the back of the phone case 600. Preferably, the antenna 601 is positioned close to the built-in NFC antenna of the smart phone, so as to ensure proper signal transfer between the NFC tag 610 of the phone case 600 and the built-in NFC reader of the smart phone.

One example of the pre-determined actions to be performed by the target electronic device is to launch an application program installed therein. For example, the pre-determined action may be taking a picture with the built-in camera of the smart phone. This is especially useful when the user wants to take a self-picture while the built-in camera is on the back side of the smart phone. Without the phone case 600, as the back side of the smart phone must face the user when taking a self-picture, said user cannot see the virtual button for taking a picture displayed on the touch screen of the smart phone, making it difficult to take the picture. When the phone case 600 is mounted to the smart phone, as the switch 603 is placed on the left side of the phone case 600, the user will be able to see and therefore precisely operate the switch 603 while facing the camera on the back of the phone. This makes taking a self-portrait picture much easier.

It is to be understood that the pre-determined action can be any one of the numerous applications that can be performed by the target electronic device, for example, visiting a specific website, or executing a task in an application program installed in the target electronic device. An especially important application of the apparatus of the present invention is to effect mobile payment, for example by a portable electronic device (PED) such as a smart phone. Presently, in a PED-based payment system such as the Google Wallet, the PED launches a certain application program to simulate itself as an NFC tag and to make communication with an external NFC reader. The simulated NFC tag contains valuable and confidential information such as account identity. When the user wants to perform a payment, he launches the NFC tag simulator program and presents the PED to the reader, which checks the information contained in the simulated NFC tag and begins the payment process. Although security authorization is conducted between the simulated NFC tag and the reader, there are still risks that the valuable and confidential information contained in the simulated NFC tag may be stolen by third-party malicious plug-in programs or viruses through un-authorized launching of the NFC tag simulator program.

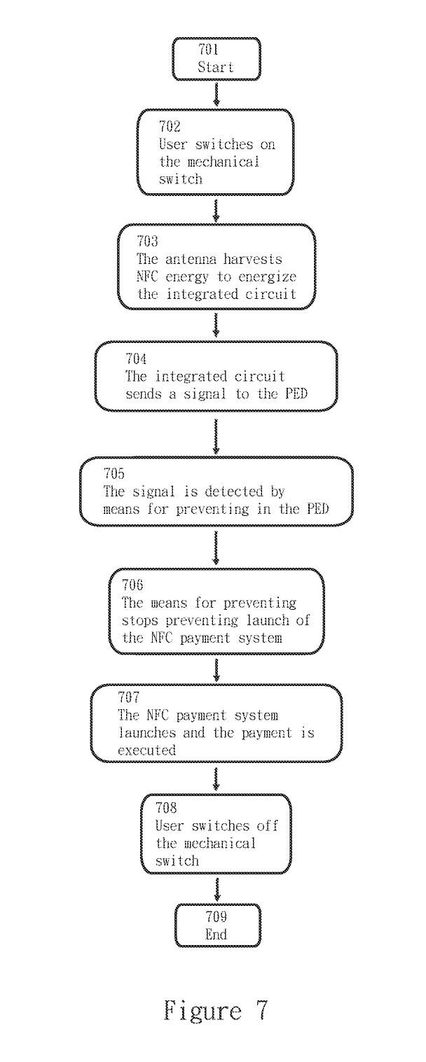

The above-mentioned risks are eliminated by the invention. The whole process of using the apparatus of the present invention to activate a PED to perform a payment is illustrated in FIG. 7. The apparatus of the fifth embodiment is used in this embodiment and a smart phone is chosen as the PED. According to the invention, a background program is pre-installed in the PED and designed for preventing launch of the payment. This background program is configured to prevent the launch of the NFC tag simulator which in turn prohibits the payment operation and the access to the confidential information of the user, if no instruction is received from the NFC tag of the apparatus of the present invention; and to permit the payment operation and access to the confidential information if a signal from the NFC tag of the apparatus of the present invention is received in the PED and the identity from the NFC tag and payment system coincides. This ensures a safe and reliable payment and eliminates the leakage of the confidential information.

In this embodiment, the mechanical switch is electrically connected to the NFC tag of the apparatus in the same way as discussed for the first embodiment. In other words, the antenna, the integrated circuit and the mechanical switch are connected in series. As illustrated in FIG. 7, the process of effecting a safe payment by the PED starts at step 701. When the user wants to effect a payment, the mechanical switch is switched to switch on the operation loop in step 702, thereby switching the operation loop into the operative state. In step 703, the antenna harvests NFC energy broadcast by the PED to energize the integrated circuit, which then sends a signal comprising the tag identification, instructions and information associated with the payment via the antenna to the PED in step 704. When the PED receives the signal in step 705, the background program is activated to stop preventing the launch of the NFC payment system in step 706. Then in step 707, the NFC payment system launches and executes the payment according to the instructions from the user. After the payment is completed, the user switches off the mechanical switch in step 708, and the process ends at step 709.

As the payment is effected only when the switch is mechanically operated by the user, unauthorized initiation of the payment operation or illegal access to the confidential information contained in the simulated NFC tag of the PED is more effectively prevented, rendering a safer payment system.

Alternatively, the mechanical switch may also be electrically connected to the NFC tag of the apparatus in the same way as discussed for the second embodiment. In this case, the operation loop is switchable between the operative state when the switch is open, and the non-operative state when the switch is closed. Therefore, in step 702, the user opens the mechanical switch in order to effect the payment, and after the payment is completed, the user closes the mechanical switch in step 708.

Another application of the apparatus of the present invention is as a non-contact input device for inputting information to the target electronic device. In this application, each of the switch devices of the apparatus of the present invention is preferably in the form of a button to press the respective operation loop into the operative state and release the respective operation loop into the non-operative state.

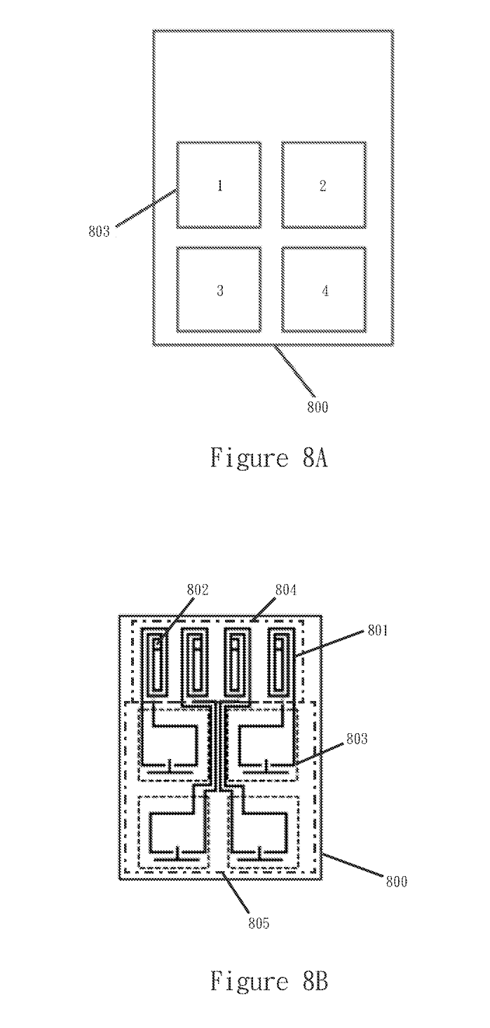

FIGS. 8A and 8B show the seventh embodiment of the present invention. A wireless keypad 800 is constructed with four buttons 803, each of the buttons 803 forming an operation loop with a respective NFC tag thereof and representing a respective number between 1 and 4. For example, when the left upper one of the buttons 803 is pressed, the respective operation loop is switched into the operative state, and a signal representing the number “1” is then sent from the respective NFC tag to the target electronic device. The right upper, left lower, and right lower buttons are respectively configured to represent numbers 2, 3, and 4. FIG. 8A shows the positional arrangement of the four buttons 803, while FIG. 8B shows the internal structure of the keypad 800. Each of the four NFC tags comprises a respective antenna 801. Each of the buttons 803 is electrically connected to the respective NFC tag as discussed for the first embodiment. In other words, the button 803, the respective antenna 801 and the respective integrated circuit 802 are connected in series. Therefore, when one of the buttons 803 is pressed, the respective integrated circuit 802 is closed, and the respective operation loop is switched to indicate the number it represents. The four antennas 801 are arranged in an antenna region 804 of the keypad 800, while the four buttons 803 are arranged in a button region 805 of the keypad 800.

Although the keypad according to this embodiment comprises four buttons 803, those skilled in the art will understand that the keypad can comprise more or less than four buttons 803, without departing from the scope of the present invention. It would also be appreciated that the input device described above may be configured as a controller for controlling various operations.

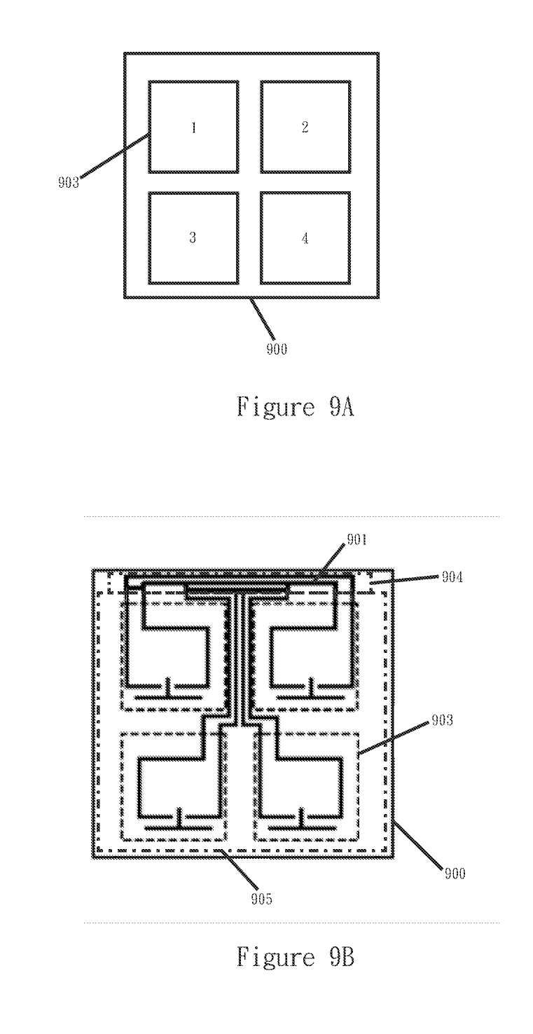

FIGS. 9A and 9B show the eighth embodiment of the present invention, which is structurally the same as the seventh embodiment illustrated in FIGS. 8A and 8B, but differs in that the four buttons 903 are configured to share a common antenna 901. FIG. 9A shows the positional arrangement of the four buttons 903, while FIG. 9B shows the internal structure of the keypad 900. The common antenna 901 is arranged in an antenna region 904 of the keypad 900, while the four buttons 903 are arranged in a button region 905 of the keypad 900. The operation of the keypad 900 is the same as the operation of the keypad 800 discussed above. By comparing the seventh embodiment and the eighth embodiment, it can be clearly seen that the “common antenna” configuration in the eighth embodiment requires a much smaller space than the “separate antenna” configuration in the seventh embodiment.

Having sufficiently described the nature of the present invention according to some preferred embodiments, the invention, however, should not be limited to the structures and functions of the embodiments and drawings. It is stated that insofar as its basic principle is not altered, changed or modified it may be subjected to variations of detail. Numerous variations and modifications that are easily obtainable by means of the skilled person's common knowledge without departing from the scope of the invention should fall into the scope of this invention.

1. An apparatus for controlling an electronic device to perform at least one pre-determined action in a batteryless manner, comprising:
at least one near field communication (NFC) tag which comprises an integrated circuit configured to activate the electronic device to perform the respective pre-determined action after the circuit is energized, and an antenna electrically coupled to the integrated circuit and configured to harvest NFC energy from the electronic device to energize the integrated circuit; and
at least one switch device configured to switch a batteryless operation loop between an operative state wherein the antenna is capable of harvesting the NFC energy to energize the integrated circuit, and a non-operative state wherein the antenna fails to harvest the NFC energy so as to disable the integrated circuit, said operation loop being formed by one of the at least one NFC tag together with the respective switch device.

2: The apparatus according to claim 1, wherein the NFC tag is configured to contain tag identification and instruction and information associated with the pre-determined action, which are readable by the electronic device to perform the respective pre-determined action.

3: The apparatus according to claim 1, wherein the at least one switch device is provided as a mechanical switch for switching on and off the integrated circuit so as to switch the operation loop between the operative state and the non-operative state.

4: The apparatus according to claim 1, wherein the at least one switch device is provided as a mechanical switch for altering a shape or a size of the antenna, for example shortening an effective length of the antenna, such that the NFC energy harvested by the integrated circuit does not suffice to activate the electronic device to perform the respective pre-determined action.

5: The apparatus according to claim 1, wherein the apparatus is detachably mounted to the electronic device, which is for example selected from the group consisting of a mobile phone, a tablet computer, and a digital camera.

6: The apparatus according to claim 1, wherein the pre-determined action is selected from the group consisting of launching an application program installed in the electronic device, visiting a website, and executing a task in an application program installed in the electronic device.

7: The apparatus according to claim 6, wherein the execution of a task comprises effecting mobile payment, the electronic device being provided with means for preventing launch of the payment unless the means for preventing receives a signal from the NFC tag.

8: The apparatus according to claim 1, wherein a plurality of NFC tags are configured to use a common antenna, or each of the NFC tags has a respective antenna.

9: The apparatus according to claim 1, wherein the switch device is in the form of a button.

10: A method for controlling an electronic device to perform a pre-determined action in a batteryless manner, comprising the steps of:
providing at least one near field communication (NFC) tag which comprises a integrated circuit configured to activate the electronic device to perform the respective pre-determined action after the circuit is energized and an antenna electrically coupled to the integrated circuit and configured to harvest NFC energy from the electronic device to energize the integrated circuit;
forming a batteryless operation loop comprising one of the at least one NFC tag;
switching the operation loop between an operative state wherein the antenna is capable of harvesting the NFC energy to energize the integrated circuit, and a non-operative state wherein the antenna fails to harvest the NFC energy so as to disable the integrated circuit.

11: The method according to claim 10, wherein the NFC tag is configured to contain tag identification and instruction and information associated with the pre-determined action, which are readable by the electronic device to perform the respective pre-determined action.

12: The method according to claim 10, wherein the switching step comprises switching on and off the integrated circuit so as to switch the operation loop between the operative state and the non-operative state.

13: The method according to claim 10, wherein the switching step comprises altering a shape or a size of the antenna, for example shortening an effective length of the antenna, such that the NFC energy harvested by the integrated circuit does not suffice to activate the electronic device to perform the respective pre-determined action

14: The method according to claim 10, further comprising the step of detachably mounting the NFC tag on the electronic device.

15: The method according to claim 10, wherein the pre-determined action is selected from the group consisting of launching an application program installed in the electronic device, visiting a website, and executing a task in an application program installed in the electronic device.

16: The method according to claim 15, wherein the execution of a task comprises effecting mobile payment, and the payment is effected only after a signal from the NFC tag is received in the electronic device.

17: (canceled)

18: (canceled)

19: An input device comprising the apparatus according to claim 1 configured as a key pad.

20: An input device comprising the apparatus according to claim 2 configured as a key pad.

21: An input device comprising the apparatus according to claim 3 configured as a key pad.

22: An input device comprising the apparatus according to claim 4 configured as a key pad.
